(19) United States
(12) Patent Application Publication
(10) Pub. No.: US 2019/0184212 A1
(43) Pub. Date: Jun. 20, 2019

(54) HOUSING OF A CLOSED CIRCUIT BREATHING APPARATUS

(71) Applicant: Dräger Safety AG & Co. KGaA, Lubeck (DE)

(72) Inventors: David CHEESMAN, Bedlington (GB); James DOCHERTY, Newcastle-upon-Tyne (GB); Conor CARR, North Tyneside (GB)

(21) Appl. No.: 16/223,591

(22) Filed: Dec. 18, 2018

(30) Foreign Application Priority Data
Dec. 19, 2017 (EP) 17 208 384.2

(51) Int. Cl. A62B 9/00; A62B 7/02

(52) U.S. Cl. CPC A62B 9/00; A62B 9/006; A62B 7/02

(57) ABSTRACT

Housing (10) of a closed circuit breathing apparatus (200), includes a primary wall (20) covering a component space (30) for receiving breathing components (210) of the closed circuit breathing apparatus (200). A secondary wall (40) covers a device space (50) at least partly inside of the component space (30). The device space (50) is sealed by the secondary wall (40) against the component space (30). The device space (50) receives an electric device (100). The device space (50) includes a device opening (52) to the surrounding of the housing (10). The device opening (52) is for inserting the electric device (100).

### CROSS REFERENCE TO RELATED APPLICATIONS

This application claims the benefit of priority under 35 U.S.C. § 119 of European Application 17 208 384.2, filed Dec. 19, 2017, the entire contents of which are incorporated herein by reference.

### TECHNICAL FIELD

The present invention is related to a housing of a closed circuit breathing apparatus, an electronic device for a closed circuit breathing apparatus, a closed circuit breathing apparatus with such a housing as well as a method for assembling a closed circuit breathing apparatus.

### BACKGROUND

It is generally known that closed circuit breathing apparatuses are used for protecting people in an unhealthy environment. To achieve that, the closed circuit breathing apparatus comprises several breathing components which are located inside of a housing of the closed circuit breathing apparatus. To enable a long use time for such a closed circuit breathing apparatus, the breathing components can, for example, comprise a CO₂ absorption component, a cooling component or a gas bottle for refilling breathing gas. To make sure that the user of the closed circuit breathing apparatus can use a breathable gas over a long period of time, the gas bottle is usually filled with oxygen, in particular pure oxygen. This leads to a situation wherein inside of the housing, an oxygen-enriched atmosphere is located. Due to the fact that usage of the closed circuit breathing apparatus in unhealthy environments can lead to the danger of explosion, the enriched oxygen atmosphere inside of the housing increases that danger. In particular, the presence of the enriched oxygen inside of the housing in combination with possibly explodable gases outside of the housing leads to a high danger of explosion, in particular with relation to the use of electronic components or battery modules.

US 2006/0201509 A1 discloses a self-contained breathing apparatus with a housing and a socket for receiving an electronic controller module. In the area of the socket, the housing is interrupted for allowing fluid communication between oxygen sensors of the module ant an inside of the housing.

To make sure that the risk of explosion is reduced significantly for the user of a closed-circuit breathing apparatus, commonly known housings comprise an electronic device in a complex and cost intensive manner, which is protected against explosion. Such a configuration is also called an EX-protected configuration. An-other possible solution is the integration of the electronic device in a handheld portion of the closed circuit breathing apparatus. Such a solution leads to the deficiencies that the handheld portion is bigger and heavier than without the integration of such an electronic device. The usability and the comfort of usage of such a closed circuit breathing apparatus is therefore reduced.

### SUMMARY OF THE INVENTION

It is an object of the present invention to overcome aforesaid problems. In particular, it is an object of the present invention to provide a cost-efficient and easy way for the configuration of the electric device in a dangerous and in particular, explosive atmosphere by the use of a closed circuit breathing apparatus.

Aforesaid object is achieved by a housing according to the invention, an electric device according to the invention, a closed circuit breathing apparatus according to the invention and a method according to the invention.

One aspect of the present invention is related to a housing of a closed circuit breathing apparatus. Such a housing comprises a primary wall covering a component space for receiving breathing components of the closed circuit breathing apparatus. The housing further comprises a secondary wall covering a device space at least partly inside of the components space. That device space is sealed against the component space and is configured to receive an electric device. Moreover, the device space comprises a device opening to the surrounding of the housing for inserting the electric device.

The core idea of the present invention is to provide a housing which combines the storage possibility of the breathing components on one side, and the electric device on the other side. Due to the fact that at least one of the breathing components usually comprises a gas bottle with the breathing oxygen, the content of the housing, in particular the component space, is an oxygen-enriched atmosphere and therefore comprises an enriched danger of explosion. To achieve an integration of the electric device in this case, a separate device space is located also inside the housing and particularly integrated in the component space. Inside of that device space, an electric device can be inserted. Such an electric device is, for example, configured to carry out some algorithms or to comprise sensors for detecting operational state or even the presence of some breathing components.

To make sure that the electric device is not correlated with any explosion danger, the device space is sealed against the component space. The sealing takes place in a gas-sealed manner such that now the oxygen-enriched atmosphere inside of the component space is in no contact with the device space and therefore is in no contact with the electric device inserted in such a device space.

Based on aforesaid general idea, the housing is provided in a very integrated manner. In contrast to state-of-the-art solutions, the electric device can be integrated in the housing. But contrary to present solutions, in which the electric device has to be configured in an EX-protected manner, in this case, the protection against the oxygen enriched atmosphere of the interior of the housing is provided by the secondary wall. The secondary wall therefore is an easy and cost efficient manner, for example produced by injection molding with a plastic material, to provide the sealing functionality between the component space on one side and the device space on the other side. Based on that sealing functionality, the electric device can be configured more freely and in particular, in a more cost efficient way, to avoid EX-protection configuration for that electric device.

Moreover, to increase the easy access to the electric device and also to enable the user of the closed circuit breathing apparatus for an easy mounting process, the device space is accessible from the surrounding of the housing directly through the device opening. In particular, the device opening comprises a geometrical relation to the outer contour of the electric device. Therefore, the electric device can be form-fitted into the device opening and thus into the device space.

Besides the easy adaption and the easy mounting process, there is no limitation as to EX-protected configuration of the electric elements inside of the electric device. Moreover, the integration of the electric device into the housing provides a mechanical protection against mechanical impact and/or vibration. Therefore, the electric elements are protected in a better manner and therefore can be used in even more unhealthy and in particular, mechanically challenging environments.

It could be of advantage, if according to the present invention, the housing comprises a mounting interface provided for reversibly mounting the electric device in a mounting position inside of the device space. That mounting can, for example, be carried out by screws or snap-fit elements. For cleaning of the housing or other parts of the breathing components, the electric device therefore can easily be removed from the housing by just demounting it from the mounting interface and moving it out through the device opening. Moreover, this is an easy access to exchange the parts of the electric elements, for example, to exchange or reload batteries. Also, the extraction of the electric device to charge internal batteries can be carried out easily by the provision of a reversibly mounting interface.

It is further of advantage, if according to the present invention, the housing is characterized in that the device space is located at a central area of the component space, in particular, surrounded completely or essentially completely by the component space. The location in a center area of the component space provides a further protection as to mechanical impact or vibration. Moreover, the integration is in close proximity to different breathing components such that a detection, which is discussed in more detail later, can be carried out more freely and more easily.

It is further of advantage that, according to the present invention, the housing is characterized in that in the device space, a device interface is located for an electric connection to the electric device inserted in the device space. Such an electric connection can, for example, comprise some plugs which are unplugged by the extraction of the electric device and which are plugged in by the insertion of the electric device. Also, in this case, a snap-fit solution can be used for such a device interface. The device interface can be used for electric communication as well as for fluid communication or for a communication connection. Also, the connection to a separate handheld used by the user of the closed circuit breathing apparatus is possible according to this embodiment of the present invention.

It is further of advantage, that according to the present invention, the housing can be characterized in that the secondary wall comprises guiding elements to guide the electric device during insertion into the device space in a mounting position, in particular, in which an electric connection with a device interface is enabled. To guide the electric device, a drawer system can be used, in particular, across the full length of the secondary wall. The guiding elements in particular are located on two opposing sides of the secondary wall to provide an easy and cost-efficient solution for that guiding functionality. These guiding elements, for example, can be located in a symmetric or essentially symmetric way on both sides of the secondary wall.

It is further of advantage that according to the present invention, the housing can be characterized in that the primary wall comprises a carrying side facing the back of a user carrying the closed circuit breathing apparatus wherein the device opening is located at least partly, in particular completely, at the carrying side of the primary wall. Usually, closed circuit breathing apparatuses are used as a backpack on the back of a user. The location of the device opening on the carrying side leads to a situation wherein during use, the back of the user covers the device opening. Therefore, an additional protection is achieved for the electric device which is now enclosed from one side by the back of the user and by the rest of the sides from the housing and the breathing components, in particular by the surrounding component space.

Further advances can be achieved if a housing, according to the present invention, is characterized in that the primary wall and the secondary wall are formed integrally or essentially integrally. This can be achieved, for example, by the use of injection molding, in particular, under the usage of a plastic material. The two walls, namely, the primary wall and the secondary wall therefore, can be configured to be monolithic and be provided in a cost-efficient and easy manner. Of course, it is also possible that besides an integral configuration, separate and different materials can be used at least partly for the primary wall on one side, and the secondary wall on the other side.

A further aspect of the present invention is an electric device for a closed circuit breathing apparatus to be inserted into a device space of an inventive housing. Such an electric device comprises electric elements and the device wall covering the electric elements wherein the device wall is orientated to align at least partly with the secondary wall of the housing in a mounting position. Due to the use of the electric device inside of the device space of an inventive housing, the electric device comes along with the same advantages discussed in detail with respect to the inventive housing. The electric elements can, for example, comprise sensors, alarming elements, calculating elements or battery modules.

Further advantages can be achieved if an inventive electric device is characterized in that the electric elements comprise a component detection module for detecting at least one breathing component located in the component space in the housing. A component detection module can, for example, comprise an RFID solution. For example, the breathing component can comprise an RFID tag, in particular, a passive RFID tag. A respective and correlated component detection module therefore can activate the passive RFID tag in proximity of itself such that now the general information of the presence of that breathing component can be recognized by the electric element, respectively the electric device. Also, a communication about operational state or the sort of the breathing component is possible with the component detection module of this embodiment. In particular, the presence of necessary breathing elements such that a CO₂ absorber, a cooler, or a gas bottle (such as an oxygen bottle) for providing/supplementing oxygen, can be provided by this embodiment.

It is further of advantage if an electric device, according to the present invention, is characterized in that the device wall comprises a closure section, closing the device opening of the device space in the mounting position. This means that the closure section correlates with the device opening in a geometric manner. After inserting the electric device inside of the device space, the closure section of the device wall closes the device opening fully or at least partly fully. The device wall and the closure section therefore have the same geometric size as the free size of the device opening.

It is possible that, according to the embodiment described above, the electric device is characterized in that a signaling element is located at the closure section for signaling an operational state of the electric elements. This can, for example, be correlated with a sensor activity, the operation state of different electric elements, or the battery level of some battery modules of the electric device. An easy and cost-efficient solution for that signaling element is, for example, the use of LEDs.

A further aspect of the present invention is a closed circuit breathing apparatus with a housing according to the present invention. The closed circuit breathing apparatus comprises at least one breathing component which is located inside of the component space and at least one electric device which is located inside of the device space. Therefore, an inventive closed circuit breathing apparatus comes along with the same advantages discussed in detail with respect to the inventive housing, as well as with respect to the inventive electric device. The components which are located inside of a housing of the closed circuit breathing apparatus comprise a CO₂ absorption component, a cooling component and a gas bottle for refilling breathing gas. To make sure that the user of the closed circuit breathing apparatus can use a breathable gas over a long period of time, the gas bottle is advantageously filled with oxygen, in particular pure oxygen.

A further aspect of the present invention is a method for assembling a closed circuit breathing apparatus according to the present invention, comprising the following steps:
inserting the electric device through the device opening in the device space in a
mounting position, mounting the inserted electric device in the mounting position.

Due to the provision of an inventive closed circuit breathing apparatus, the inventive method comes along with the same advantages as discussed in detail with respect to the inventive housing, the inventive electric device, as well as the inventive closed circuit breathing apparatus.

The present invention is discussed in more detail with respect to the accompanying drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a first embodiment of an inventive housing without the electric device;

FIG. 2 is a schematic view of the embodiment according to FIG. 1 with the integrated electric device;

FIG. 3 is a perspective view of one embodiment of an electrical device;

FIG. 4 is a side view of the embodiment according to FIG. 3;

FIG. 5 is a perspective view of the embodiment according to FIGS. 3 and 4 inserted in a housing of a closed circuit breathing apparatus; and

FIG. 6 is a cross-sectional side view of the embodiment according to FIG. 5.

### DESCRIPTION OF PREFERRED EMBODIMENTS

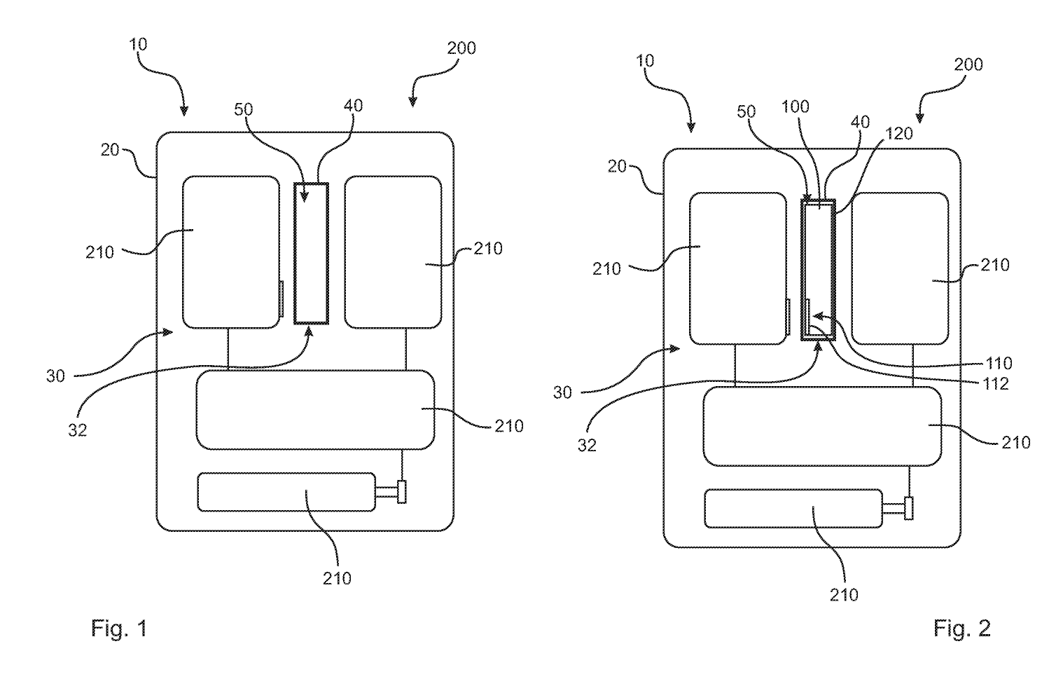

Referring to the drawings, FIGS. 1 and 2 show a first embodiment of an inventive housing 10. In FIG. 1, the housing 10 of a closed circuit breathing apparatus 200 comprises a primary wall 20, surrounding the component space 30. Inside of the component space 30 in this case several breathing components 210 are located and shown in a schematic manner. In particular, this breathing components 210 comprise a cooler, a breathing bag, a gas bottle (such as an oxygen bottle) as well as a CO₂ absorber.

In a center area of the component space 30, a secondary wall 40 seals a separate device space 50 from the component space 30. The correlation and the possibility of the insertion of the electric device 100 is discussed later.

FIG. 2 shows how the integration of the electric device 100 can take place. The electric device 100 is now inserted in the device space 50 and therefore the electric device 100 is surrounded by the secondary wall 40 and thereby sealed against the breathing components 210 inside of the component space 30. One of the electric elements 110 is a component detection module 112 which can now communicate, for example, with a passive RFID tag on the breathing component 210 on the left side. The presence of that breathing component 210 or even the operational state of that breathing component 210 can therefore be communicated to the electric device 100.

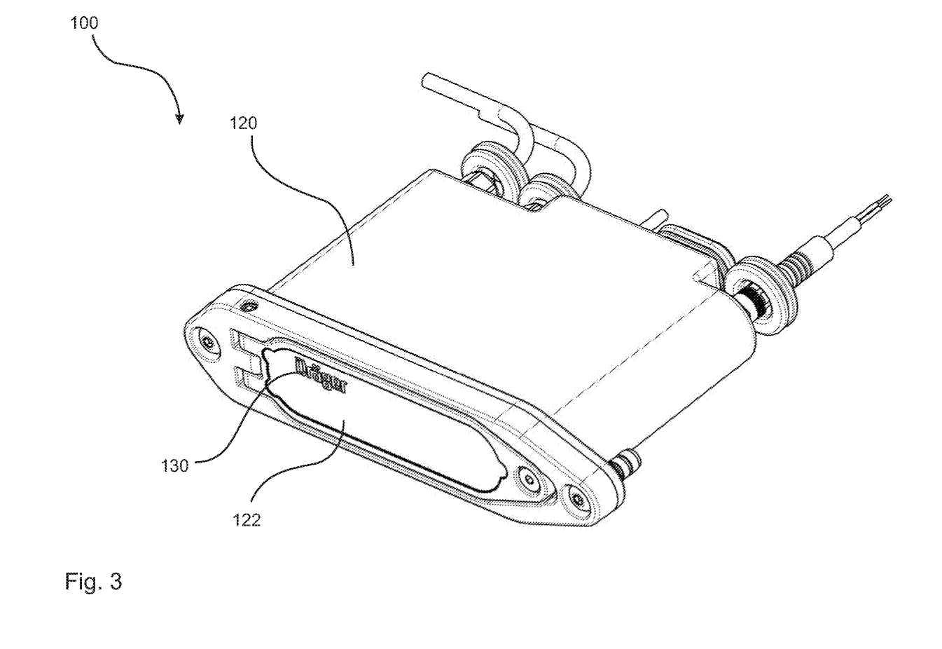

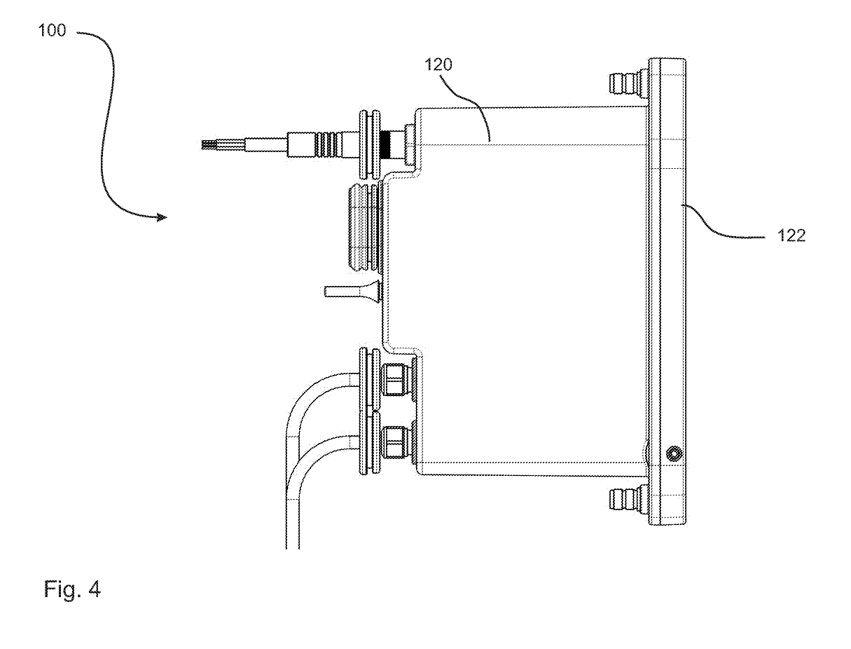

FIGS. 3 and 4 show one possibility of an electric device 100. This electric device 100 comprises device walls 120 which can be aligned with the secondary wall 40 inside of the housing 10. A closure section 122 is correlated in a geometrical manner with the respective device opening 52 of the device space 50. To make sure that even without the extraction of the electric device 100 the operational state of some of the electric elements 110, for example, the battery charge status of the battery modules can be signaled, a signaling element 130 is located on the closure section 122.

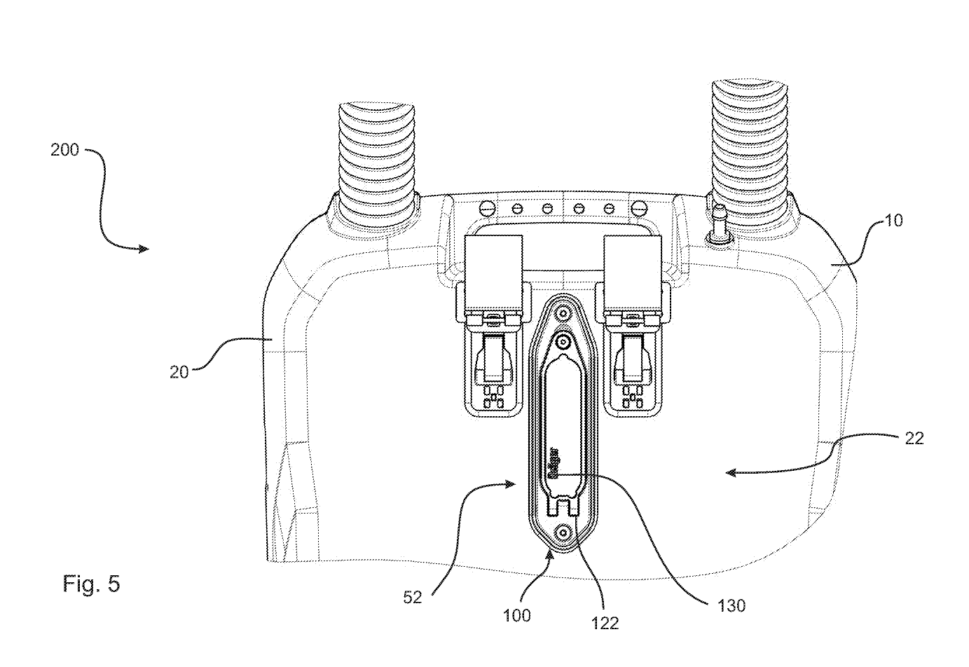

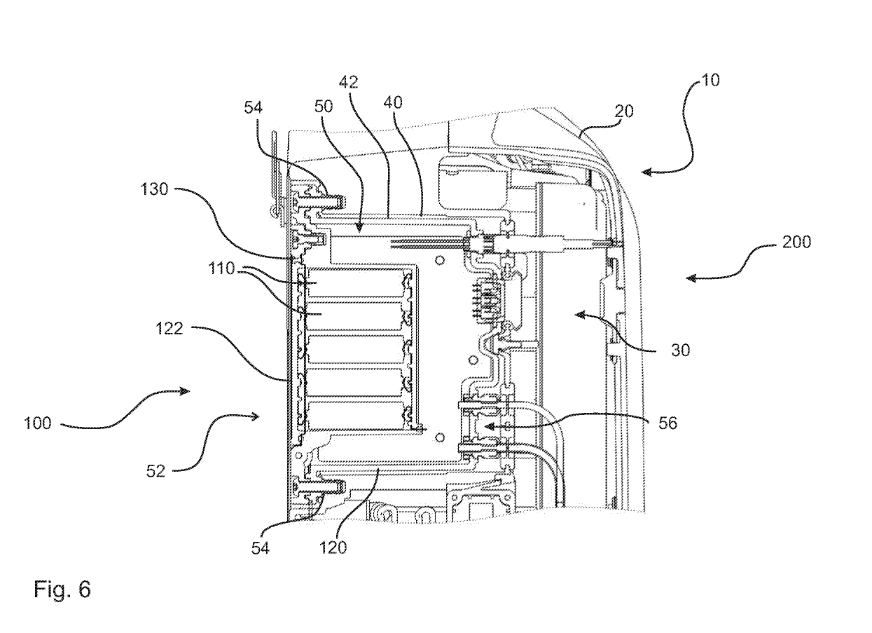

The integration of the electric device 110 of the embodiment according to FIGS. 3 and 4 can be seen in FIGS. 5 and 6. FIG. 5 now shows the housing 10 facing the carrying side 22 of their primary wall 20. Into a device opening 52, the electric device 100 is inserted by closing the device opening 52 with the closure section 122. In the cross-sectional view according to FIG. 6, the correlation inside of the housing 10 is shown. The device wall 120 aligns with the secondary wall 40. To mount the electric device 100 in the position, according to FIG. 6, screws are used as a mounting interface 54 in an upper and lower section. Moreover, electric elements 110 in form of battery modules can be seen. To make sure that in an easy and cost efficient manner an electric or a fluid communication can take place, a device interface 56 can be seen inside of the device space 50. To provide an easy and cost-efficient mounting procedure, guiding elements 52 are located at the secondary wall 40 to guide the electric device 100 during the move in the mounting position which is described and shown in FIGS. 5 and 6.

Of course, aforesaid description of the accompanying drawings is only by way of detail and example. Specific features of each aspect of the present invention and the figures can be combined with each other if of technical sense.

While specific embodiments of the invention have been shown and described in detail to illustrate the application of the principles of the invention, it will be understood that the invention may be embodied otherwise without departing from such principles.

What is claimed is:

1. A closed circuit breathing apparatus housing for a closed circuit breathing apparatus, the closed circuit breathing apparatus housing comprising:
a primary wall covering a breathing component space for receiving breathing components of the closed circuit breathing apparatus; and
a secondary wall covering an electric device space for receiving an electric device, the secondary wall being at least partly inside of the component space and the secondary wall forming a seal, whereby the electric device space is sealed relative to the component space, wherein the secondary wall comprises an electric device opening from the electric device space to a surrounding of the closed circuit breathing apparatus for inserting the electric device into the electric device space from the surrounding of the closed circuit breathing apparatus.

2. A closed circuit breathing apparatus housing according to claim 1, further comprising a mounting interface in the electric device space, the mounting interface for reversibly mounting the electric device in a mounting position inside of the electric device space.

3. A closed circuit breathing apparatus housing according to claim 1, wherein the electric device space is located at a center area of the component space and at least partially surrounded by the component space.

4. A closed circuit breathing apparatus housing according to claim 1, further comprising an electric device interface in the electric device space, the electric device interface being located for an electric connection to the electric device inserted in the electric device space.

5. A closed circuit breathing apparatus housing according to claim 4, wherein the secondary wall comprises guiding elements to guide the electric device with insertion of the electric device into the electric device space in a mounting position to enable an electric connection with the electric device interface.

6. A closed circuit breathing apparatus housing according to claim 1, wherein:
the primary wall comprises a carrying side facing a back of a user carrying the closed circuit breathing apparatus; and
the device opening is located at least partly at the carrying side of the primary wall.

7. A closed circuit breathing apparatus housing according to claim 1, wherein the primary wall and the secondary wall are formed integrally or essentially integrally.

8. An electric device for a closed circuit breathing apparatus to be inserted in a electric device space of a closed circuit breathing apparatus housing comprising a primary wall covering a breathing component space for receiving breathing components of the closed circuit breathing apparatus and a secondary wall covering an electric device space for receiving the electric device, the secondary wall being at least partly inside of the component space and the secondary wall forming a seal, whereby the electric device space is sealed relative to the component space, wherein the secondary wall comprises an electric device opening from the electric device space to a surrounding of the closed circuit breathing apparatus for inserting the electric device into the electric device space from the surrounding of the closed circuit breathing apparatus, the electric device comprising:
electric elements; and
a device wall covering the electric elements, wherein the device wall is configured and orientated to align at least partly with the secondary wall of the housing in a mounting position.

9. An electric device according to claim 8, wherein the electric elements comprise a component detection module configured to detect at least one breathing component located in the component space of the housing.

10. An electric device according to claim 9, wherein the device wall comprises a closure section closing the electric device opening of the electric device space in the mounting position.

11. An electric device according to claim 10, further comprising a signaling element located at the closure section and configured to signal an operational state of the electric elements.

12. A closed circuit breathing apparatus comprising:
a closed circuit breathing apparatus housing comprising a primary wall covering a breathing component space for receiving breathing components of the closed circuit breathing apparatus and a secondary wall covering an electric device space for receiving an electric device, the secondary wall being at least partly inside of the component space and the secondary wall forming a seal, whereby the electric device space is sealed relative to the component space, wherein the secondary wall comprises an electric device opening from the electric device space to a surrounding of the closed circuit breathing apparatus for inserting the electric device into the electric device space from the surrounding of the closed circuit breathing apparatus;
a breathing component located inside of the component space; and
an electric device comprising electric elements and a device wall covering the electric elements, wherein the device wall is configured and orientated to align at least partly with the secondary wall of the housing in a mounting position located inside of the electric device space.

13. A closed circuit breathing apparatus according to claim 12, wherein the housing further comprises a mounting interface in the electric device space, the mounting interface for reversibly mounting the electric device in a mounting position inside of the electric device space.

14. A closed circuit breathing apparatus according to claim 12, further comprising an electric device interface in the electric device space, the electric device interface being located for an electric connection to the electric device inserted in the electric device space.

15. A closed circuit breathing apparatus according to claim 14, wherein the secondary wall comprises guiding elements to guide the electric device with insertion of the electric device into the electric device space in a mounting position to enable an electric connection with the electric device interface.

16. A closed circuit breathing apparatus housing according to claim 12, wherein:
the primary wall comprises a carrying side facing a back of a user carrying the closed circuit breathing apparatus;
the device opening is located at least partly at the carrying side of the primary wall;
the electric device space is located at a center area of the component space and at least partially surrounded by the component space; and
the primary wall and the secondary wall are formed integrally or essentially integrally.

17. A closed circuit breathing apparatus according to claim 12, wherein the electric elements comprise a component detection module configured to detect at least one breathing component located in the component space of the housing.

18. A closed circuit breathing apparatus according to claim 17, wherein the device wall comprises a closure section closing the electric device opening of the electric device space in the mounting position.

19. A closed circuit breathing apparatus according to claim 18, further comprising a signaling element located at the closure section and configured to signal an operational state of the electric elements.

20. A method for assembling a closed circuit breathing apparatus, the method comprising the steps of:
providing a closed circuit breathing apparatus housing comprising a primary wall covering a breathing component space for receiving breathing components of the closed circuit breathing apparatus and a secondary wall covering an electric device space for receiving an electric device, the secondary wall being at least partly inside of the component space and the secondary wall forming a seal, whereby the electric device space is sealed relative to the component space, wherein the secondary wall comprises an electric device opening from the electric device space to a surrounding of the closed circuit breathing apparatus for inserting the electric device into the electric device space from the surrounding of the closed circuit breathing apparatus;
providing a breathing component located inside of the component space;
providing an electric device comprising electric elements and a device wall covering the electric elements, wherein the device wall is configured and orientated to align at least partly with the secondary wall of the housing in a mounting position located inside of the electric device space;
inserting the electric device through the device opening into the electric device space; and
mounting the inserted electric device in the mounting position.
